(19) United States
(12) Patent Application Publication
(10) Pub. No.: US 2006/0041210 A1
(43) Pub. Date: Feb. 23, 2006

(54) Portable sealed water jet female stimulator

(76) Inventor: Eyal Regey, Coral Springs, FL (US)

Correspondence Address: Donald W. Meeker,;Patent Agent, 924 East Ocean Front #E, Newport Beach, CA, 92661, US

(21) Appl. No.: 10/924,708

(22) Filed: Aug. 23, 2004

(51) Int. Cl. A61H 19/00

(52) U.S. Cl. 601/148; 600/38; 601/150

(57) ABSTRACT

A water pump directs a jet or focused stream of water at a water-proof flexible membrane adapted to stimulate a female genital area. The water, re-circulating in a closed system inside a casing, may be heated, pulsed, swirled, and directed in a steady stream. The device may be held by hand or used hands free on a base or strapped to the body.

### BACKGROUND OF THE INVENTION

1. Field of the Invention

The present invention relates to female stimulators, and in particular to a female stimulator using an adjustable water jet against a membrane in a sealed portable unit.

2. Description of the Prior Art

Today's market is saturated with a great variety and large number of female stimulation products. Vibrators are sold in many different shapes, sizes and materials. Most if not all vibrating products are using a vibrating device mechanism (bullet).

While some women use water in a shower or bath tub as a source of stimulation, the prior art provides no devices producing a similar water stimulation which are portable to be used anywhere without squirting water all over.

U.S. Pat. No. 6,350,230, issued Feb. 26, 2002 to Kontos, shows a sexual aid device for producing sexual stimulation having an elongated upper member, an elongated lower member, a means for removably securing the upper and lower members together, a tube member, and a compression means for ejaculating liquid from the tube member. An upper end of the upper member has an aperture therethrough. The elongated lower member has a compartment therein for one or more batteries for powering the device. The tube member has a compressible liquid containment unit on a lower end thereof. A hollow neck member extends upward from the liquid containment unit, the hollow neck member being in fluid communication with the liquid containment unit. The neck member has an open upper end. During use the tube member is positioned inside the device such that the open upper end of the neck member is inserted in the aperture of the upper member. The compression means is configured and positioned to compress the liquid containment unit to thereby ejaculate liquid from the tube member. The device is preferably provided with a vibration means, a timing unit, and a heating element, all of which may be selectively used as needed when using the device to provide sexual stimulation. Methods of using the device are also provided.

U.S. Pat. No. 6,099,463, issued Aug. 8, 2000 to Hockhalter, is for a female stimulation device comprised of a tubular suction chamber sized for closely fitting around a clitoris. The suction chamber is connected to a variable partial vacuum source through a tubing. The partial vacuum source may be the mouth of a user or a mechanical device, such as a vacuum bulb or pump. The clitoris is drawn outwardly by the partial vacuum, so that it is engorged with blood to produce a sexually pleasurable sensation. The force of suction may be controlled by a check and suction release valve, which is also used to release the partial vacuum. The front end of the suction chamber is shaped to provide an air-tight but comfortable seal.

U.S. Pat. No. 5,920,923, issued Jul. 13, 1999 to Jillette, claims a spa of a type including a tub for holding water and a user, in particular, a female user. The spa has a seat for supporting the female user in a seated position, a circulation pump having an inlet connected to the tub for drawing water from the tub, and an outlet connected to the tub for discharging the drawn water back to the tub. A discharge nozzle is located within the tub and connected to the outlet, mounted to the seat so that the discharged water from the circulation pump automatically aligns with and is directed to stimulation points (e.g., the clitoris) of the female user when the female user sits in the seat.

U.S. Pat. No. 3,598,106, issued Aug. 10, 1971 to Buning, describes a longitudinally extending fluid filled deformable member adapted to be inserted into the vaginal canal to facilitate voluntary exercise of the muscles of the pelvic diaphragm and a fluid conduit connecting such device to an external indicator means to provide visible indicia of such muscular constrictions.

What is needed is a female genital stimulating device which produces a pulsating or swirling or continuous stream water sensation but with the water jet shielded in a container with a dry thin film contacting the user.

### SUMMARY OF THE INVENTION

An object of the present invention is to provide a female genital stimulating device which produces a pulsating or swirling or continuous stream water stimulation but with the water jet shielded in a container with a dry thin film contacting the user.

The present invention water jet stimulation against a dry thin film contacting the user with the water contained within the device is a novel construction. There is no other product on the market that utilizes contained water pressure to create a unique clitoral stimulation. The effect of the soft constant pressure of the pulsating water stream through the thin latex film result in a very special sensation.

Another object of the present invention is to provide a water stimulation device which is adjustable in pressure and temperature and pulsation or swirling rhythm.

One more object of the present invention is to provide a hydro female stimulation device with an internal water cycling system using a pump feed for the pulsating stream of water and a gravity return to a water reservoir which may be heated as desired.

An additional object of the present invention is to make a hydro female stimulation device which is inexpensive and easy to manufacture.

A further object of the present invention which simulates a hand shower spray for female stimulation but without the water splashing around, so it can be used anywhere.

Still one more object of the present invention is to provide a water based female stimulation device which may be used hands free on a stand or strapped on or held by hand.

In brief, a water pump shoots a pulsating, swirling or steady stream (jet) of water against a thin layer of latex-like film. The water drains back down into the water tank to be recycled. The water pump will continuously pump the water and shoot it onto the film. The reservoir may be used to heat the water as desired. The effect of the impact of the water jet hitting on the latex film simulates the effect of a hand held showerhead in a bath (or better) when placed to contact a clitoris.

The device contains four main parts: pump, front film, tank and the handle. The water pump is attached on top of the water tank. The suction nuzzle of the pump is lowered into the tank through the water sealer and below the water level. The pump sucks the water up and shoots the water through the discharge nuzzle in a pulsating, swirling, or steady stream directly onto the thin latex like film, preferably focused on a small point on the film.

The discharge nuzzle is extended out through the front cap. The film is attached around to the front cap. The film is attached to the front cap with a special groove around it. After the water jet hits the film the water drains down through the return flow and the return flow valve back into the water tank. The battery is located directly above the pump or adjacent to the pump above the water tank. Both the pump and the battery are located inside the casing of the device which has a handle area for holding the device. The control switch is located on the handle for ease of use. An optional attachment socket is located on the front of the water tank and just below the front cap and the film. The user is able (optional) to use different insertion attachments protruding from the device directly below the film.

The unique attributes and advantages of the present invention include:
1. Unique/ novel: new type of female stimulation simulating a water pulse but used dry on the exterior with the water contained.
2. Compact/portable.
3. Familiar but different: simulates a water spray, such as a hand-held shower head, but it is used dry since the water is contained behind a thin Latex film.
4. Tested and proven effective in producing the desired female stimulation.
5. Does not look like a sex toy but more like a tooth care or medical device.
6. Use different temperatures, spray characteristics and attachments for variety.
7. Concept could be used in different embodiments (hand held, hands free on base, hands free on a belt, remote control or control via a computer) Provides steady flow, swirling or pulsation (preferred substitute for vibration) and insertion motion in one product.
8. Easy to clean and hygienically safe with replaceable Latex outer film.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a side elevational diagrammatic view of the portable sealed moving liquid female stimulator of the present invention with an insertion element aligned for attachment;

FIG. 1A is a perspective view of the portable sealed moving liquid female stimulator of the present invention having a liquid return area around an entire perimeter of the flexible membrane connecting ring;

FIG. 2 is a side elevational diagrammatic view of the portable sealed moving liquid female stimulator of the present invention with an insertion element mounted on a pump positioned adjacent to a bottom of the stimulator device;

FIG. 3 is a side elevational diagrammatic view of the portable sealed moving liquid female stimulator of the present invention removably mountable on a base with a centrally mounted water jet and film; liquid female stimulator of the present invention with a flexible arm supporting a stimulating head with the water jet and film and an optional strap for attaching it to a user;

FIG. 5 is a side elevational diagrammatic view of a hands-free embodiment of the portable sealed moving liquid female stimulator of the present invention mounted on a stable base with a wired remote control for the device;

FIG. 6 is a side elevational diagrammatic view of a long handled embodiment of the portable sealed moving liquid female stimulator of the present invention;

FIG. 7 is a front elevational diagrammatic view of the portable sealed moving liquid female stimulator of the present invention with a casing structured in a human form.

### BEST MODE FOR CARRYING OUT THE INVENTION

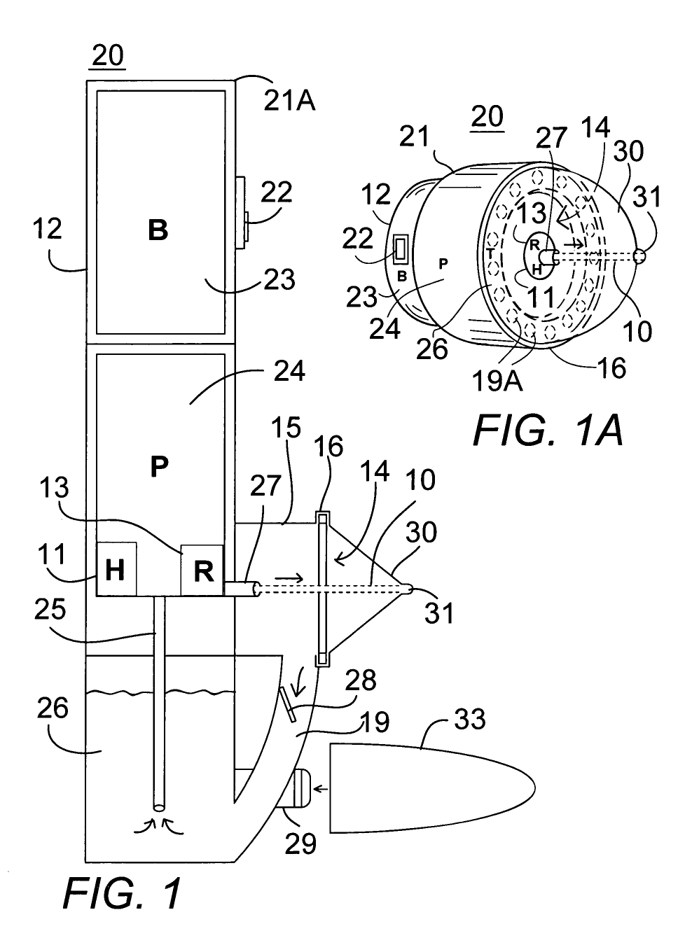

In FIGS. 1-7, a hydro female stimulator device 20 comprises a liquid pump 24 for directing a focused stream or jet of liquid 10, such as water, from a reservoir 26 onto a thin flexible waterproof membrane 30 for stimulating a genital area of a female, the water re-circulated and contained within the device.

A water-tight housing 15 and 15A has an opening 14 with a flexible water proof membrane 30, preferably a Latex film, removably attached to the water tight housing by a removable cap 16 over the opening. The membrane 30 is removable and replaceable for cleaning the membrane or substituting a new membrane. A water reservoir 26 communicates with the at least one water-tight housing 15 via a pump 24 for pumping a flow of water through a collection tube 25 from the reservoir 26 into the housing 15 and 15A and a gravity feed return channel 19 for returning the water back into the reservoir 26 for re-circulation, which channel may have a one-way hinged cover 28 to allow gravity flow of water from the water-tight housing 15 to the reservoir 26, but prevent water from the reservoir 26 flowing directly into the water-tight housing 15 should the device be tilted over.

A water nozzle 27 in the water-tight housing 15 is adapted for directing the flow of water from the pump 24 in a focused stream of water 10 onto a stimulator area 31, which may protrude slightly, on the membrane 30. The membrane 30 is adapted to expand away from the casing under pressure from the focused stream of water 10, as indicated by the dome shape of the membrane 30 which is flat when the pump is off, so that the stimulator area 31 of the membrane is adapted to be positioned to contact a genital area of a female user to stimulate the genital area. The device is adapted to retain a quantity of water therein and to re-circulate the quantity of water through the pump 26, the water tight housing, and the reservoir 24.

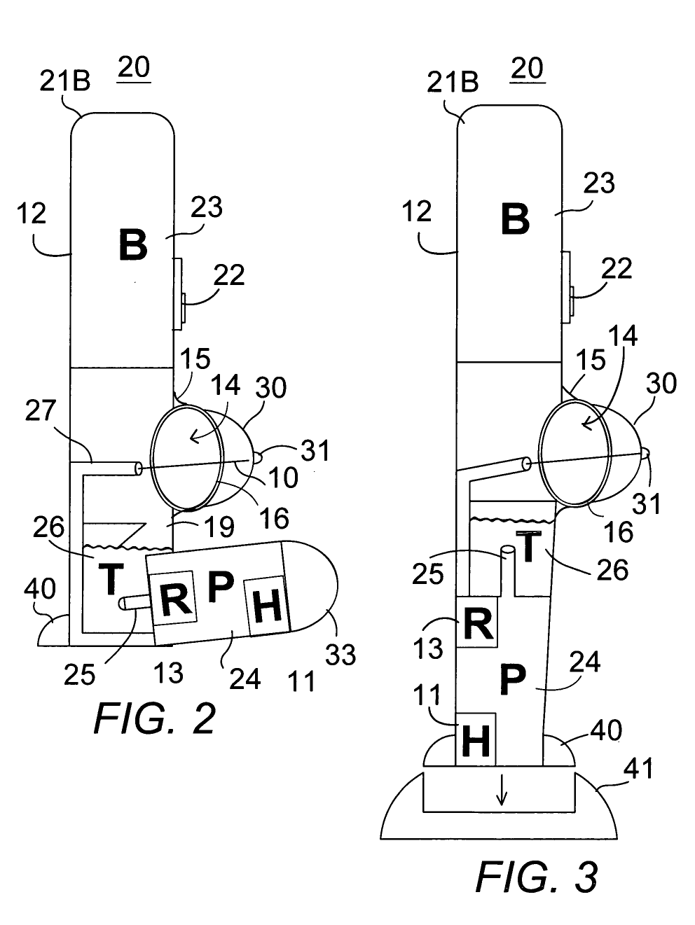

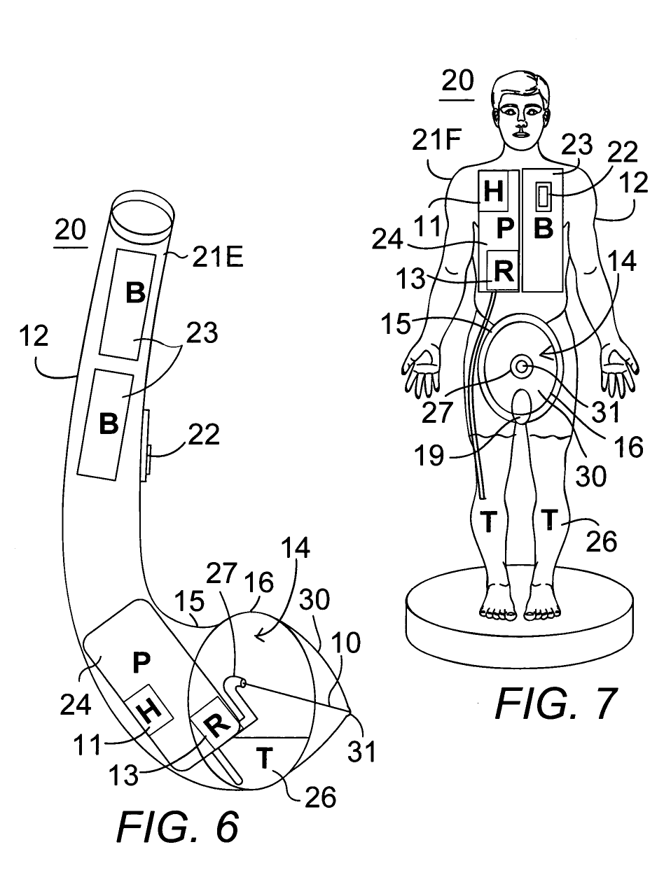

A handle portion 12 is adapted to be held by a hand of a user to position the device. A control switch 22 to control the pump is preferably located in the handle portion 12 for ease of use. In FIGS. 1, 2, 3, 6, and 7, the handle portion 12 is part of the casing 21A-21F which also houses the battery 23, pump 24, and reservoir 26 as well as the water-tight housing 15 with the membrane 30. Alternately there may be a straight casing 21A (FIG. 1) and 21B (FIGS. 2 and 3), or a curved casing 21E (FIG. 6) or shaped casing 21F (FIG. 7) which simulates a shape of a man.

In FIG. 1A, a contained moving liquid female stimulator device 20 comprises a liquid tight housing 21 comprising a liquid 10, such as water, contained within the housing, a flexible liquid impermeable membrane 30 exposed on an exterior of the housing, the membrane adapted to contact a genital area of a female user, and a pump 24 as a means for moving the liquid in the direction of the flexible membrane 30, preferably in a focused stream of liquid 10, on a stimulator area 31 which protrudes from the membrane, so that a movement of the liquid in contact with the membrane is adapted to stimulate a genital area of a female user in contact with the membrane. The stimulator area 31 protrudes from the membrane 30 a sufficient distance for contacting a clitoris of a female user with the membrane contacting a genital area of a female user.

The pump 24 and nozzle 27 may pump a steady jet of liquid 10 at the stimulator area 31 of the membrane 30 and it may have a built-in adapter R 13 connected with the pump and the nozzle for varying the flow of the focused stream of liquid 10, creating a pulsating jet or a swirling jet of liquid at the stimulator area 31 of the membrane 30.

A circular return liquid collector area 26 may be an annular reservoir or tank T with liquid return openings 19A or the liquid return openings 19A may comprise a series of tubes conducting the liquid from the membrane area back into the pump 26.

The battery holding portion 23 outside of the pump 26 may serve as a handle 12 for the device and the control switch 22 may be positioned on the battery holding portion 23 for convenience of use.

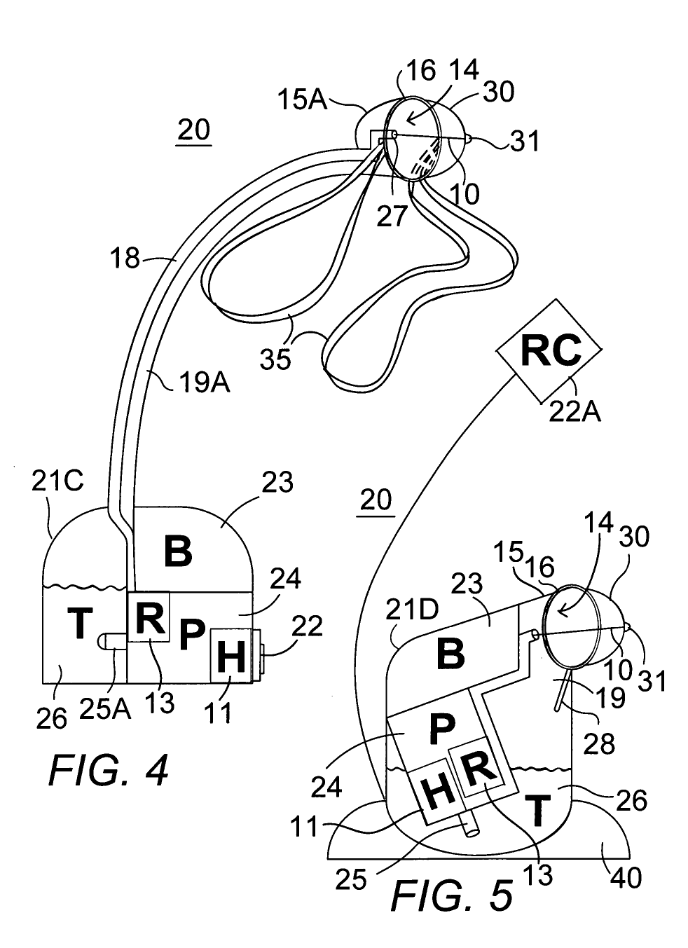

The device may have a base portion 40, as in FIGS. .2, 3, and 7 adapted to rest on a surface for storage or in the case of the low profile casing 21D of FIG. 5 to enable a user to position a user's body in contact with the device for hands free operation of the device. The hands free embodiment with the low profile casing 21D preferably has a remote control 22A for the pump 24. A recharging base 41 (FIG. 3) may also be used for storing and recharging the battery 23 of the device.

In FIG. 4 the water-tight housing 15A with the membrane 30 is positioned remotely from the casing 21C which houses the reservoir 26, pump 24 and battery source 23 and connected to the casing by a water outflow line 18 and a water return line 19A. An optional body securing element 35, such as adjustable or elasticized straps may be used to attach the water-tight housing 15A with the membrane 30 to a body of user for hands free operation of the device by wrapping the straps around the legs of the user.

In FIGS. 1 and 2, the device may further comprise a female genital penetration element 33, such as a dildo element, positioned below the membrane 30 and extending outwardly from the device. The female genital penetration element 33 is adapted to be removable from the device and further comprising a variety of shapes and sizes of female genital penetration devices adapted to be attached interchangeably to the device. In FIG. 1, the female genital penetration element 33 attaches by friction or a threaded connection to a post 29. In FIG. 2 the pump 24 protrudes out of the casing 21B and the female genital penetration element 33 is a removable extension of the pump 24.

The device may further comprise an adjustable heating element 11, which may be built into or attached to the pump 24, for heating the quantity of water contained in the device to a desired temperature.

The device may further comprise a regulator 13 built into or attached to the pump 24, as a means for creating a pulsating or swirling or twisting stream of water 10 onto the membrane as alternatives to a normal steady stream of water 10.

In use, the device is operated on low voltage and is harmless. The water level in the reservoir 26 should be checked before use, and filled up to a marked water line if necessary, which can be accomplished through the opening 14 by removing the membrane 30. The latex film or other membrane 30 would then be secured over the opening 14 by a snap fit or threaded cap 16 to create a water-tight seal.

The Latex film could be replaced as needed. Battery operated models install batteries and turn on/off switch to the desirable intensity.

For AC adapter operated models, the adapter is plugged into the outlet and the control switch 22 and 22A turned to the desirable speed. The device is designed to be operated in the up right position only. Water may be drained when not in use for a period of time and when transporting the device and the water replaced as needed (once a month or more).

The device is turned on and positioned adjacent to the female genital area to cause stimulation.

It is understood that the preceding description is given merely by way of illustration and not in limitation of the invention and that various modifications may be made thereto without departing from the spirit of the invention as claimed.

What is claimed is:

1. A contained moving liquid female stimulator device comprising:
a liquid tight housing comprising a liquid contained within the housing, a flexible liquid impermeable membrane exposed on an exterior of the housing, the membrane adapted to contact a genital area of a female user, and a means for moving the liquid in the direction of the flexible membrane so that a movement of the liquid in contact with the membrane is adapted to stimulate a genital area of a female user in contact with the membrane.

2. The device of claim 1 wherein the means for moving the liquid is adapted to focus a flow of liquid at a stimulator area of the flexible liquid impermeable membrane, the stimulator area protruding from the membrane a sufficient distance for contacting a clitoris of a female user with the membrane contacting a genital area of a female user.

3. The device of claim 2 wherein the means for moving the liquid comprises a pump and nozzle adapted to direct a focused stream of liquid at the stimulator area of the membrane.

4. The device of claim 3 further comprising a means for creating a steady jet of liquid at the stimulator area of the membrane.

5. The device of claim 3 further comprising a means for varying the flow of the focused stream of liquid.

6. The device of claim 5 further comprising a means for creating a pulsating jet of liquid at the stimulator area of the membrane.

7. The device of claim 5 further comprising a means for creating a swirling jet of liquid at the stimulator area of the membrane.

8. A flowing liquid female stimulator device comprising:
at least one liquid-tight housing having an opening with a flexible liquid impervious membrane attached by a liquid tight means to attach the membrane over the opening in the housing, a liquid reservoir communicating with the at least one liquid-tight housing, a pump for pumping a flow of a liquid from the reservoir into the at least one liquid-tight housing, a liquid nozzle in the at least one water-tight housing adapted for directing a flow of liquid from the pump in a focused stream of liquid onto a stimulator area of the membrane, the membrane adapted to expand away from the casing under pressure from the focused stream of liquid so that the stimulator area of the membrane is adapted to be positioned to contact a genital area of a female user to stimulate the genital area, the device adapted to retain a quantity of liquid therein and to re-circulate the quantity of liquid through the pump, the at least one liquid-tight housing, and the reservoir.

9. The device of claim 8 wherein the device is adapted to use water as a liquid in the device.

10. The device of claim 8 wherein the liquid tight means to attach the membrane is adapted to enable a removing and a replacing of the membrane.

11. The device of claim 8 wherein the at least one liquid-tight housing further comprises a handle portion adapted to be held by a hand of a user to position the device.

12. The device of claim 11 wherein the handle portion further comprises a control for the pump.

13. The device of claim 8 wherein the at least one liquid-tight housing further comprises a base portion adapted to rest on a surface and support the device to enable a user to position a user's body in contact with the device for hands free operation of the device.

14. The device of claim 13 further comprising a remote control for the pump.

15. The device of claim 8 wherein the at least one liquid-tight housing further comprises a body securing element to attach the at least one water-tight housing to a body of user for hands free operation of the device.

16. The device of claim 8 wherein the at least one liquid-tight housing, the reservoir, and the pump are all housed in a single casing.

17. The device of claim 8 wherein the pump is powered by an electric motor and the device further comprises a battery source of power for the pump.

18. The device of claim 8 further comprising a female genital penetration element positioned below the membrane and extending outwardly from the device.

19. The device of claim 18 wherein the female genital penetration element is adapted to be removable from the device and further comprising a variety of shapes and sizes of female genital penetration devices adapted to be attached, interchangeably to the device.

20. The device of claim 8 further comprising an adjustable heating element for heating a quantity of liquid contained in the device.

21. The device of claim 8 further comprising a means for creating a pulsating stream of water onto the membrane.

22. The device of claim 1 further comprising a means for creating a swirling stream of water onto the membrane.

23. The device of claim 1 wherein the membrane comprises a Latex film removably attached to the at least one liquid tight housing by a removable cap over the opening in the at least one liquid tight housing.
